(19) United States
(12) Patent Application Publication
(10) Pub. No.: US 2018/0196308 A1
(43) Pub. Date: Jul. 12, 2018

(54) ARRAY SUBSTRATE, TRANSPARENT DISPLAY SUBSTRATE, TRANSPARENT DISPLAY DEVICE AND VEHICLE

(71) Applicant: BOE Technology Group Co.,Ltd., Beijing (CN)

(72) Inventors: Xiaoling Xu, Beijing (CN); Yuanxin Du, Beijing (CN); Yanfeng Wang, Beijing (CN); Yun Qiu, Beijing (CN); Dan Wang, Beijing (CN); Xue Dong, Beijing (CN)

(21) Appl. No.: 15/552,008

(22) PCT Filed: Feb. 16, 2017
(86) PCT No.: PCT/CN2017/073779

§ 371 Date: Aug. 18, 2017

(30) Foreign Application Priority Data
Nov. 7, 2016 (CN) 201610539965.7

(51) Int. Cl. G02F 1/1335

(52) U.S. Cl. CPC G02F 1/133536; G02F 2001/133548; G02F 1/133514

(57) ABSTRACT

The disclosure provides an array substrate, a transparent display substrate, a transparent display device and a vehicle including the transparent display device. The array substrate includes: a transparent substrate; a plurality of pixel units formed on the transparent substrate; and a wire grid polarizer formed on the transparent substrate. A position of the wire grid polarizer on the transparent substrate corresponds to a position where the plurality of pixel units are located on the transparent substrate, such that an orthographic projection of the wire grid polarizer on the transparent substrate fully or partially overlap orthographic projections of the plurality of pixel units on the transparent substrate.

### CROSS-REFERENCE TO RELATED APPLICATIONS

The present application claims priority to Chinese Patent Application No.201610539965.7, filed on Jul. 11, 2016 before the Chinese Patent Office, which is incorporated herein by reference in its entirety.

### TECHNICAL FIELD

Embodiments of the present disclosure generally relate to technical field of display, and particularly to an array substrate, a transparent display substrate, a transparent display device and a vehicle including the transparent display device.

### DESCRIPTION OF THE RELATED ART

Transparent display is utilized in more applications, such as head-up display in a vehicle, window display, etc. FIG. 1 shows a conventional transparent display panel, including a transparent substrate 100 and devices attached onto the transparent substrate 100. A polarizing sheet 101 is provided and attached to the transparent substrate 100. The transparent display panel may further include other devices for displaying, such as a thin film transistor 102, liquid crystal 103, another polarizing sheet 104 and another transparent substrate 100′, which are similar to the devices used in a conventional liquid crystal panel. The transparent display panel may allow ambient light to be transmitted therethrough. However, light transmittance of the existing transparent display panel is rather low and is substantially less than 30%, which is partially attributed to a lower light transmittance of the polarizing sheet.

### SUMMARY

The present disclosure is provided to overcome at least one of the above and other problems defects in the prior arts.

An object of the present disclosure is to provide an array substrate, a transparent display substrate, a transparent display device and a vehicle including the transparent display device, for increasing light transmittance of the array substrate, the transparent display substrate, and the transparent display device.

According to an aspect of the present disclosure, there is provided an array substrate including: a transparent substrate; a plurality of pixel units formed on the transparent substrate; and a wire grid polarizer formed on the transparent substrate; a position of the wire grid polarizer on the transparent substrate corresponds to a position where the plurality of pixel units are located on the transparent substrate, such that an orthographic projection of the wire grid polarizer on the transparent substrate fully or partially overlap orthographic projections of the plurality of pixel units on the transparent substrate.

In an embodiment, the wire grid polarizer comprises a strip element array composed of a plurality of strip elements, the strip element array being arranged such that each of the strip elements transmits therethrough a light component of incident light in a preset polarization direction while reflecting a light component of the incident light in a polarization direction orthogonal to the preset polarization direction.

In an embodiment, each of the pixel units comprises one or more sub-pixel portions and a position of each of the strip elements on the transparent substrate corresponds to a position of each of the sub-pixel portions on the transparent substrate, such that an orthographic projection of the strip element on the transparent substrate at least partially overlap an orthographic projection of the corresponding sub-pixel portion on the transparent substrate.

In an embodiment, each of the pixel units comprises a plurality of sub-pixel portions and a first light transmission region is provided between adjacent sub-pixel portions of each of the pixel units, or

a second light transmission region is provided between adjacent pixel units and no light transmission region is provided among the plurality of sub-pixel portions of each of the pixel units.

In an embodiment, a third light transmission region is provided between adjacent strip elements at a position corresponding to the first light transmission region and/or the second light transmission region.

In an embodiment, a width of each of the strip elements of the wire grid polarizer is equal to a width of a corresponding sub-pixel portion.

In an embodiment, a width of each of the strip elements of the wire grid polarizer is less than a width of a corresponding sub-pixel portion.

In an embodiment, a width of each of the strip elements of the wire grid polarizer is equal to a half of a width of a corresponding sub-pixel portion.

In an embodiment, each of the strip elements of the wire grid polarizer comprises a material having electrically conductive and light reflective properties.

In an embodiment, each of the strip elements comprises a plurality of material lines, a separation distance between the material lines is in a range from 40 nm to 150 nm, and a thickness of each material line is in a range from 40 nm to 150 nm.

In an embodiment, materials of the material lines include a metal or an electrically conductive polymer.

In an embodiment, the array substrate further includes a protective layer provided on a side of the wire grid polarizer facing away from the transparent substrate to cover the wire grid polarizer.

In an embodiment, the wire grid polarizer is located at the same side of the transparent substrate as the plurality of sub-pixel portions.

In an embodiment, the wire grid polarizer is located at a side of the transparent substrate opposite from the plurality of sub-pixel portions.

In an embodiment, each of the pixel units comprises a plurality of sub-pixel portions including a blue sub-pixel portion, a red sub-pixel portion and a green sub-pixel portion.

According to another aspect of the present disclosure, there is provided a transparent display substrate including the above array substrate.

In an embodiment, a color filter layer is further provided on the array substrate of the transparent display substrate.

According to a further aspect of the present disclosure, there is provided a transparent display device including the above array substrate or the above transparent display substrate.

According to a still further aspect of the present disclosure, there is provided a vehicle including a head-up display system, the head-up display system including the above transparent display device.

### BRIEF DESCRIPTION OF THE DRAWINGS

FIG. 1 is a cross sectional view showing a structure of a conventional transparent array substrate;

FIG. 2 is a cross sectional view showing a structure of an array substrate used for transparent displaying according to an embodiment of the present disclosure;

FIG. 3 is a cross sectional view showing a structure of an array substrate used for transparent displaying according to another embodiment of the present disclosure;

FIGS. 4a-c are schematic diagrams showing arrangements of pixel units and a wire grid polarizer according to an embodiment of the present disclosure, where FIGS. 4a and 4b schematically show an arrangement of pixel units according to an embodiment of the present disclosure and FIG. 4c schematically shows an arrangement of a wire grid polarizer according to an embodiment of the present disclosure;

FIG. 5 is a cross sectional view showing a structure of an array substrate used for transparent displaying according to a further embodiment of the present disclosure;

FIG. 6 is a cross sectional view showing a structure of an array substrate used for transparent displaying according to a still further embodiment of the present disclosure; and

FIGS. 7a-b are enlarged views of a wire grid polarizer according to an embodiment of the present disclosure, where FIG. 7a is an enlarged plan view and FIG. 7b is an enlarged cross sectional view.

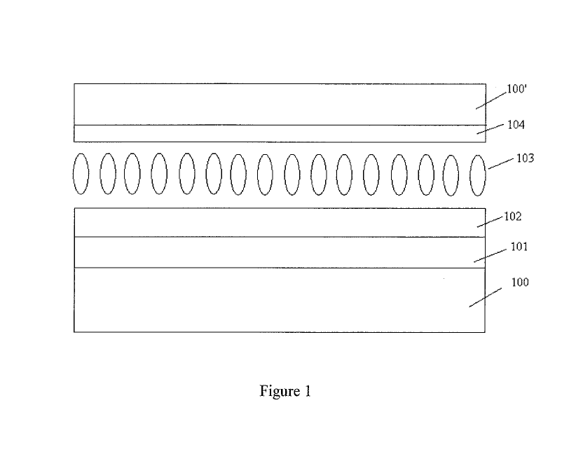

### DETAILED DESCRIPTION OF PREFERRED EMBODIMENTS

In order to make objects, technical schemes and advantages of the present disclosure more definite, embodiments of the present disclosure will be further described in detail with reference to the drawings. In this description, like or similar reference numerals refer to like or similar elements. Description of the embodiments of the present disclosure made with reference to the drawings tends to describe general concepts of the disclosure, and should not be understood as being limitative to the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

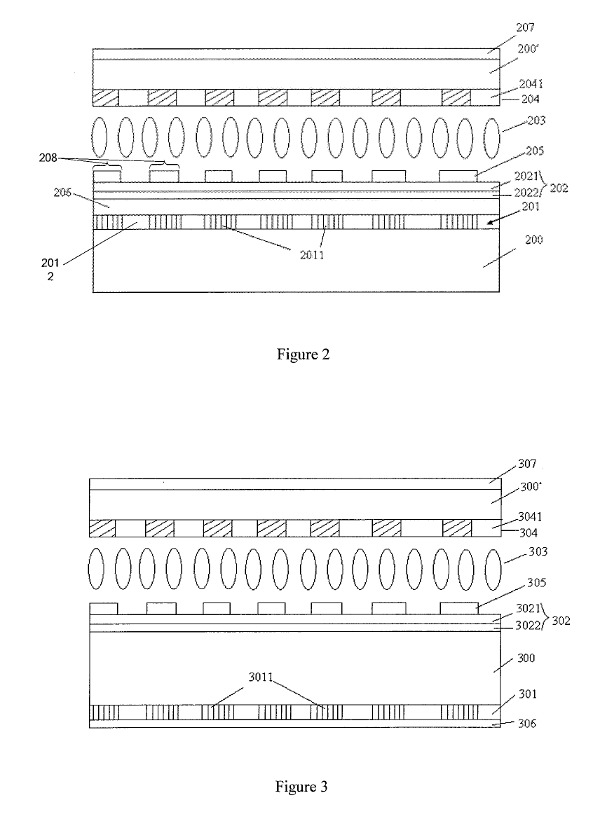

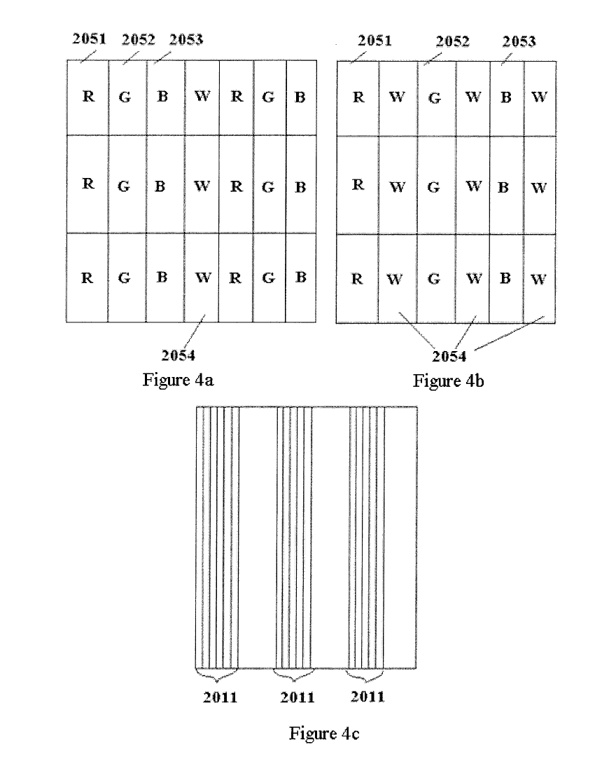

According to an embodiment of the present disclosure, there is provided an array substrate, as shown in FIG. 2, including: a transparent substrate 200; and, a plurality of pixel units 208 formed on a side of the transparent substrate, each pixel unit including one or more sub-pixel portions 205. In FIG. 2, each sub-pixel portion is schematically indicated by an electrode 205. The sub-pixel portion may include, for example, a plate electrode 2022, an insulating layer 2021, a strip electrode 205. Herein, the strip electrode 205 is illustrated just in a schematic indication manner. In fact, one pixel unit may include a plurality of strip electrodes, and the structure of the pixel is known by those skilled in the art. In an embodiment, the plate electrode may be a common electrode and the strip electrode may be a pixel electrode. In another embodiment, the plate electrode may be a pixel electrode and the strip electrode may be a common electrode. The array substrate may further include a wire grid polarizer 201 formed on a side of the transparent substrate and a position of the wire grid polarizer on the transparent substrate is corresponding to a position where the plurality of pixel units are located on the transparent substrate. Exemplarily, an orthographic projection of the wire grid polarizer on the transparent substrate partially overlaps orthographic projections of a plurality of pixel units on the transparent substrate. In an example, the wire grid polarizer 201 includes a strip element array composed of a plurality of strip elements 2011. FIG. 4c illustrates an enlarged schematic view of a wire grid polarizer.

According to embodiments of the present disclosure, the wire grid polarizer 201 is arranged such that each strip element 2011 transmits therethrough a light component of incident light (for example, ambient light) in a preset polarization direction while reflecting a light component of the incident light in a polarization direction orthogonal to the preset polarization direction. Positions where the strip elements 2011 are located on the transparent substrate are respectively in one-to-one correspondence to positions where the sub-pixel portions are located on the transparent substrate.

In an embodiment of the present disclosure, each strip element 2011 of the wire grid polarizer includes a material having electrically conductive and light reflective properties. For example, each strip element of the wire grid polarizer includes a plurality of material lines made of metal. In other words, each strip element of the wire grid polarizer includes a plurality of metal lines. The metal line may be an aluminum line, a chromium line, a silver line, or an alloy line formed by an alloy of aluminum, silver or chromium. In some situations, each strip element of the wire grid polarizer includes a plurality of lines made of electrically conductive polymers.

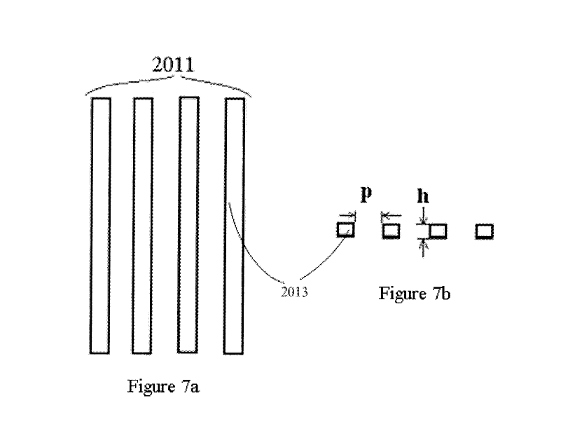

According to an embodiment of the present disclosure, a material film such as a metal material film may be deposited on the transparent substrate, and then the deposited material film is etched, thereby forming a plurality of strip elements 2011 each including a plurality of material lines on the transparent substrate. As schematically shown by vertical lines in FIGS. 4a-c and a plurality of strip lines in FIGS. 7a-b, each strip element 2011 includes a plurality of material lines 2013.

Specifically, a patterning process may be performed using a mask during deposition of the material film to obtain a preliminary pattern of the material film. For example, a strip material belt is firstly deposited on the substrate by using a mask, and then the material belt is etched through an etching process by using a mask to obtain a material line (such as metal line) microstructure of each strip element 2011, thereby forming a final strip element array 201 or wire grid polarizer 201.

In another embodiment of the present disclosure, the strip element array or wire grid polarizer 201 may be directly formed through deposition by using a mask, such that each strip element 2011 has a material line (such as metal line) microstructure and no etching process is needed.

FIGS. 7a-b are enlarged schematic views of a single strip element 2011. The strip element 2011 includes a plurality of material lines, which may be formed, such as, by deposition and etching process as described above. The strip element 2011 may also be formed by directly depositing a plurality of material lines in a manner of deposition in which a mask is used. FIG. 7a is an enlarged plan view of a strip element and FIG. 7b is enlarged cross sectional view of a strip element. Exemplarily, a separation distance p between the material lines may be in a range from 40 nm to 150 nm. A height or thickness h of each material line may be in a range from 40 nm to 150 nm. The separation distance p and height h of the material line may be set by those skilled in the art according to a wavelength of light that is to be transmitted.

An operation principle of a wire grid polarizer is known in the art. When electromagnetic radiation or light with a certain wavelength is incident to the strip element 2011, a polarization light component of the light with a polarization direction parallel to the wire grid element is reflected by the strip element 2011 while a polarization light component of the light with an orthogonal polarization direction is transmitted through the strip element 2011 if the separation distance p between the material lines of the strip element 2011 is in a range from a half to about two times of the wavelength.

According to embodiments of the disclosure, positions of the plurality of strip elements 2011 of the wire grid polarizer 201 on the transparent substrate are respectively in one-to-one correspondence to positions of the plurality of pixel units on the transparent substrate. In other words, orthographic projections of the plurality of strip elements 2011 of the wire grid polarizer 201 on the transparent substrate respectively correspond to or at least partially overlap orthographic projections of the plurality of sub-pixel portions on the transparent substrate. For example, in FIG. 2, the transparent substrate 200 includes a plurality of sub-pixel portions 205, which may include, for example, a red sub-pixel portion, a green sub-pixel portion or a blue sub-pixel portion. In an embodiment, the plurality of sub-pixel portions include a red sub-pixel portion R, a green sub-pixel portion G and a blue sub-pixel portion B, which are arranged with a certain cycle, such as a cycle of RGB-RGB-RGB. In other words, the pixel units are arrayed on the transparent substrate and each pixel unit includes an array of RGB. With this configuration, positions where the strip elements 2011 of the wire grid polarizer 201 are located on the transparent substrate are respectively in one-to-one correspondence to positions where the red sub-pixel portion R, the green sub-pixel portion G and the blue sub-pixel portion B, which are arranged with a certain cycle, are located on the transparent substrate. In other words, orthographic projections of the strip elements 2011 of the wire grid polarizer 201 on the transparent substrate partially or fully overlap orthographic projections of the plurality of sub-pixel portions on the transparent substrate respectively.

FIGS. 4a and 4b are enlarged views schematically showing structures of two typical pixel units. The pixel units in FIGS. 4a and 4b include red sub-pixel portions 2051 (denoted by R), green sub-pixel portions 2052 (denoted by G) and blue sub-pixel portions 2053 (denoted by B), and intervals or light transmission regions (denoted by W) 2054 between two sub-pixel portions. In this situation, orthographic projections of the strip elements 2011 of the wire grid polarizer 201 on the transparent substrate respectively correspond to, such as partially or fully overlap, orthographic projections of the red sub-pixel portions 2051, the green sub-pixel portions 205) and the blue sub-pixel portions 2053 on the transparent substrate. In FIG. 4a, a light transmission region 2054 is provided between a RGB pixel unit and another adjacent RGB pixel unit; the R, G, B sub-pixel portions of a RGB pixel unit are arranged side by side or adjacent to one another and no light transmission region is provided among them. In FIG. 4b, a light transmission region 2054 is provided between a sub-pixel portion and another adjacent sub-pixel portion. Correspondingly, no strip element 2011 is provided at a position corresponding to the light transmission region 2054. Corresponding to the arrangement in FIG. 4a where a plurality of pixel units are spaced apart from one another, a light transmission region is provided at an interval of every three strip elements. Further, corresponding to the arrangement in FIG. 4b where a light transmission region is provided between a sub-pixel portion and another adjacent sub-pixel portion, a light transmission region 2012 is provided between adjacent strip elements (see FIG. 2). It is advantageous because spacing or interval among the sub-pixel portions and strip elements, that is, the light transmission regions, may transmit the ambient light and thus increase light transmittance of the transparent substrate while maintaining the display resolution of the transparent substrate.

It is appreciated that, however, the strip elements of the wire grid polarizer may also be provided at positions corresponding to the intervals or the light transmission regions 2054. In this configuration, the light transmission regions may still transmit part of the light.

According to an embodiment of the present disclosure, a light transmission region is provided between every two ones of the sub-pixel portions in each pixel unit, that is, the sub-pixel portions are spaced apart from one another, and the light transmission region may be provided among the plurality of pixel units, that is, the pixel units are spaced apart from one another. In this situation, one light transmission region is provided between every two ones of the sub-pixel portions on the substrate.

It is appreciated that it is also possible that no light transmission region may be provided among the pixel units.

According to another embodiment of the present disclosure, each pixel unit may include one sub-pixel portion, two sub-pixel portions or three sub-pixel portions, which may be determined as required. For example, in situation where one pixel unit includes one sub-pixel portion, the pixel unit includes one type of sub-pixel portion. In another embodiment, a plurality of sub-pixel portions of a pixel unit may only include a combination of a red light sub-pixel portion and a blue sub-pixel portion. In an embodiment, a plurality of sub-pixel portions of a pixel unit may include a combination of a green sub-pixel portion and a blue sub-pixel portion. In an embodiment, a plurality of sub-pixel portions of a pixel unit may only include a combination of a green sub-pixel portion and a red sub-pixel portion. The sub-pixel portions are arranged close to one another so as to form an array, or, they are arranged one by one, forming an array. In another embodiment of the present disclosure, light transmission regions are provided among the pixel units. In another embodiment of the present disclosure, the sub-pixel portions are arranged to be spaced apart from one another. In other words, light transmission portions are provided among the sub-pixel portions of the pixel units. Each pixel unit may include three types of sub-pixel portions, or may include two types of sub-pixel portions, or may include only one type of sub-pixel portion, which may be determined as required.

In an embodiment of the present disclosure, a width of each strip element 2011 of the wire grid polarizer is the same as a width of a corresponding sub-pixel portion 2051, 2052, 2053. In other words, an orthographic projection of each strip element 2011 of the wire grid polarizer on the transparent substrate may fully overlap or coincide with an orthographic projection of the corresponding sub-pixel portion 2051, 2052, 2053 on the transparent substrate.

In another embodiment of the present disclosure, a width of each strip element 2011 of the wire grid polarizer is the same as a width of a corresponding sub-pixel portion 2051, 2052, 2053, and an orthographic projection of each strip element 2011 of the wire grid polarizer on the transparent substrate may partially overlap an orthographic projection of the corresponding sub-pixel portion 2051, 2052, 2053 on the transparent substrate, that is, the orthographic projections are staggered by a certain amount.

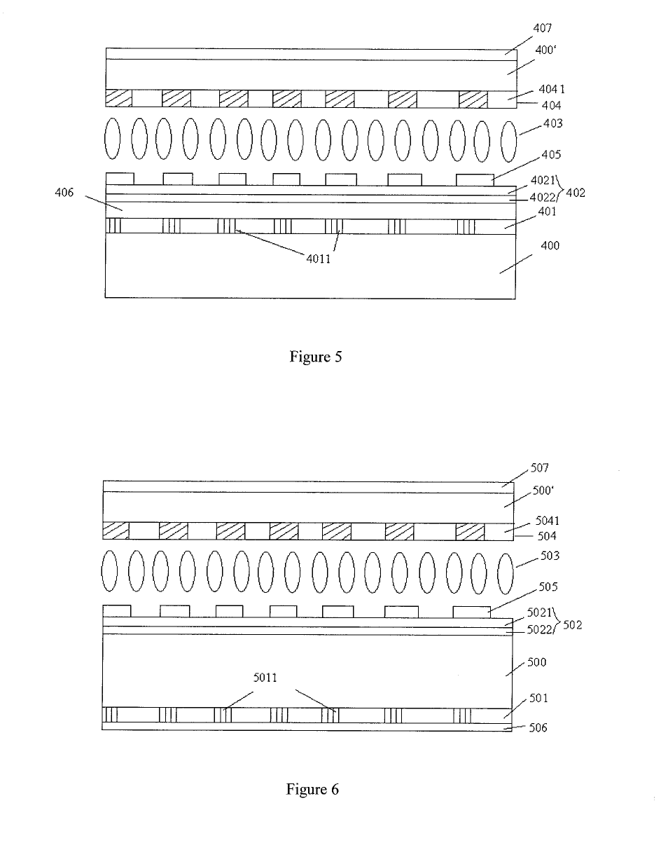

In another embodiment of the present disclosure, a width of each strip element 2011 of the wire grid polarizer is less than a width of a corresponding sub-pixel portion 2051, 2052, 2053. This case is illustrated in FIGS. 5 and 6, in which a width of the strip element 4011 or 5011 is less than a width of a sub-pixel portion. In this situation, an orthographic projection of each strip element 2011 on the transparent substrate may be located within an orthographic projection of the corresponding sub-pixel portion on the transparent substrate.

In a still embodiment of the present disclosure, a width of each strip element 4011 or 5011 of the wire grid polarizer is half of a width of a corresponding sub-pixel portion 2051, 2052, 2053. As the width of each strip element of the wire grid polarizer is reduced, light transmittance of the transparent substrate is thus largely increased while maintaining a sufficient display resolution.

In an embodiment of the present disclosure, as shown in FIG. 2, the array substrate may further include a protective layer 206 provided on a layer where the wire grid polarizer is located to protect the wire grid polarizer. The array substrate may further include a thin film transistor structure (which may include structures indicated by reference numbers 202, 302, 402, 502), which is formed on the protective layer 206.

In the embodiment shown in FIG. 2, the wire grid polarizer 201 is located on the same side of the transparent substrate 200 as the sub-pixel portion indicated by reference number 205 in Figure, for example, on an upper side or light-emitting side of the transparent substrate 200 as shown in FIG. 2.

FIG. 3 illustrates another embodiment of the present disclosure. The array substrate in FIG. 3, similar to that in FIG. 2, includes a transparent substrate 300, and sub-pixel portions 305 formed on an upper side of the transparent substrate 300. The sub-pixel portions 305 are arranged on the upper side or light-emitting side of the transparent substrate. Different from the structure shown in FIG. 2, the array substrate further includes a wire grid polarizer 301 on a lower side or light incidence side of the transparent substrate 300. The wire grid polarizer 301 has similar structure and functions as that shown in FIG. 2. The wire grid polarizer 301 in FIG. 3 is covered by a protective layer 306.

As shown in FIG. 3, it is different from FIG. 2 in that the wire grid polarizer is located on a side of the transparent substrate 300 opposite from the sub-pixel portion 305. The embodiment as shown in FIG. 3 may be provided to simplify processes of manufacturing the array substrate.

Another embodiment of the present disclosure is illustrated in FIG. 5. The array substrate in FIG. 5 includes a transparent substrate 400 and a plurality of sub-pixel portions 405 formed on an upper side of the transparent substrate 400. The arrays substrate further includes a wire grid polarizer 401 formed on an upper side of the transparent substrate 400. The wire grid polarizer 401 has similar structure and functions as the wire grid polarizer 201 shown in FIG. 2. The wire grid polarizer 401 shown in FIG. 5 is covered by a protective layer 406, and a thin film transistor layer 402 is located on the protective layer 406.

The difference of embodiment shown in FIG. 5 from the embodiment shown in FIG. 2 is in that the width of each strip element of the wire grid polarizer 401 is greatly reduced such that, for example, the width of each strip element may be only half of the width of the sub-pixel portion. Embodiment as shown in FIG. 5 may be provided such that light transmittance of the transparent substrate is greatly increased while maintaining a sufficient display effect.

Another embodiment of the present disclosure is illustrated in FIG. 6. An array substrate shown in FIG. 6 includes a transparent substrate 500 and a plurality of sub-pixel portions 505 formed on an upper side of the transparent substrate 500. The array substrate further include a wire grid polarizer 501 formed on a lower side of the transparent substrate 500, and the wire grid polarizer 50 has similar structure and functions as the wire grid polarizer 201 shown in FIG. 5. The wire grid polarizer 501 shown in FIG. 6 is covered by a protective layer 506.

As shown in FIG. 6, a width of each strip element of the wire grid polarizer is largely reduced such that, for example, the width of each strip element is only half of a width of the sub-pixel portion. The embodiment shown in FIG. 6 is provided such that light transmittance of the transparent substrate is largely increased while maintaining a sufficient display effect. Further, the strip elements in the embodiment shown in FIG. 6 are formed on the lower side or light incidence side of the transparent substrate such that processes of manufacturing the array substrate are simplified.

An embodiment of the present disclosure further provides a transparent display substrate, including any one of the above array substrates. In the embodiment, the transparent display substrate further includes a color filter layer.

In a further embodiment of the present disclosure, the transparent display substrate further includes a color filter layer, a black matrix and a post spacer. That is, in the embodiment, the layers of the color filter substrate in prior art are formed on the array substrate, and thus a process of assembling an array substrate and a color filter substrate into a cell may be omitted. According to the embodiment of the present disclosure, the problem of undesirable defects caused by poor assembling accuracy may be essentially solved, and an aperture ratio may be increased and quality of a panel may be improved.

In another embodiment of the present disclosure, a transparent display device includes the above array substrate. As shown in FIG. 2, the transparent display device may further include another substrate, such as a glass substrate 200′ and a color filter layer 204 formed on a side of the glass substrate 200′. For example, as shown in FIG. 2, the color filter layer 204 includes a light transmission region 2041 (or corresponding locations in other Figures indicated by other reference numbers such as 3041, 4041) arranged to correspond to or align with the light transmission region of the wire grid polarizer. The array substrate may further include a liquid crystal layer 203 located between the transparent substrate 200 and the substrate 200′. In another embodiment, the color filter layer 204 may be provided on a side of the substrate 200. The structures and functions of the color filter layer 204 and the liquid crystal layer 203 are known by those skilled in the art and will not be repeated herein.

In another embodiment of the present disclosure, a transparent display device includes any one of the above transparent substrates.

An embodiment of the present disclosure provides a vehicle including a head-up display system, the head-up display system including the above transparent display device.

Although the present disclosure has been illustrated and described with reference to exemplary embodiments of the disclosure, it is appreciated that various modification and changes in detail and form may be made without departing from spirit and scope of the present disclosure defined in the appended claims and their equivalents.

1. An array substrate, comprising:
a transparent substrate;
a plurality of pixel units formed on the transparent substrate; and
a wire grid polarizer formed on the transparent substrate;
wherein a position of the wire grid polarizer on the transparent substrate corresponds to a position where the plurality of pixel units are located on the transparent substrate, such that an orthographic projection of the wire grid polarizer on the transparent substrate fully or partially overlap orthographic projections of the plurality of pixel units on the transparent substrate.

2. The array substrate according to claim 1, wherein the wire grid polarizer comprises a strip element array composed of a plurality of strip elements, the strip element array being arranged such that each of the strip elements transmits therethrough a light component of incident light in a preset polarization direction while reflecting a light component of the incident light in a polarization direction orthogonal to the preset polarization direction.

3. The array substrate according to claim 2, wherein each of the pixel units comprises one or more sub-pixel portions and a position of each of the strip elements on the transparent substrate corresponds to a position of each of the sub-pixel portions on the transparent substrate, such that an orthographic projection of the strip element on the transparent substrate at least partially overlap an orthographic projection of the corresponding sub-pixel portion on the transparent substrate.

4. The array substrate according to claim 2, wherein each of the pixel units comprises a plurality of sub-pixel portions and a first light transmission region is provided between adjacent sub-pixel portions of each of the pixel units, or
a second light transmission region is provided between adjacent pixel units and no light transmission region is provided among the plurality of sub-pixel portions of each of the pixel units.

5. The array substrate according to claim 4, wherein a third light transmission region is provided between adjacent strip elements at a position corresponding to the first light transmission region and/or the second light transmission region.

6. The array substrate according to claim 3, wherein a width of each of the strip elements of the wire grid polarizer is equal to a width of a corresponding sub-pixel portion.

7. The array substrate according to claim 3, wherein a width of each of the strip elements of the wire grid polarizer is less than a width of a corresponding sub-pixel portion.

8. The array substrate according to claim 3, wherein a width of each of the strip elements of the wire grid polarizer is equal to a half of a width of a corresponding sub-pixel portion.

9. The array substrate according to claim 2, wherein each of the strip elements of the wire grid polarizer comprises a material having electrically conductive and light reflective properties.

10. The array substrate according to claim 2, wherein each of the strip elements comprises a plurality of material lines, a separation distance between the material lines is in a range from 40 nm to 150 nm, and a thickness of each material line is in a range from 40 nm to 150 nm.

11. The array substrate according to claim 10, wherein materials of the material lines include a metal or an electrically conductive polymer.

12. The array substrate according to claim 1, further comprising a protective layer provided on a side of the wire grid polarizer facing away from the transparent substrate to cover the wire grid polarizer.

13. The array substrate according to claim 3, wherein the wire grid polarizer is located at the same side of the transparent substrate as the plurality of sub-pixel portions.

14. The array substrate according to claim 3, wherein the wire grid polarizer is located at a side of the transparent substrate opposite from the plurality of sub-pixel portions.

15. The array substrate according to claim 1, wherein each of the pixel units comprises a plurality of sub-pixel portions including a blue sub-pixel portion, a red sub-pixel portion and a green sub-pixel portion.

16. A transparent display substrate, comprising the array substrate according to claim 1.

17. The transparent display substrate according to claim 16, wherein the array substrate is further provided thereon with a color filter layer.

18. A transparent display device, comprising the array substrate according to claim 1.

19. A vehicle comprising a head-up display system, the head-up display system comprising the transparent display device according to claim 18.

20. A transparent display device, comprising the array substrate according to claim 17.
